(19) United States
(12) Patent Application Publication
(10) Pub. No.: US 2011/0097946 A1
(43) Pub. Date: Apr. 28, 2011

(54) ELECTRICAL CONNECTOR WITH EACH TERMINAL HAVING PIERCE PORTIONS AND REVERSE-HOOK PORTIONS FOR POSITIONING

(76) Inventor: Wan-Tien CHEN, Taipei (TW)

(21) Appl. No.: 12/605,865

(22) Filed: Oct. 26, 2009

(51) Int. Cl. H01R 9/24

(52) U.S. Cl. 439/708

(57) ABSTRACT

The present invention relates to an electrical connector, comprises: an insulation housing having a plurality of first terminal channels and a plurality of second terminal channels; a plurality of first conduction terminals for transferring power signals, and each of the first conduction terminals has a contact portion, a positioning portion and a jointing portion; and a plurality of second terminal channels; a plurality of second conduction terminals for transferring signals, and each of the second conduction terminals has a contact portion, a positioning portion and a jointing portion. Two ends of each of the positioning portions of the first conduction terminals and two ends of each of the positioning portions of the second conduction terminals are respectively installed with at least one reversed-hook portion or at least one pierce portion for preventing the first conduction terminals and the second conduction terminals from shaking and rotating.

### BACKGROUND OF THE INVENTION

1. Field of the Invention

The present invention relates to an electrical connector, more particularly to an electrical connector in which at least one scoop hole being installed on an insulation housing for reducing the shrinking and deformation of the insulation housing, and each positioning portion of conduction terminals having at least one reversed-hook portion or at least one pierce portion for preventing the conduction terminals from shaking and rotating.

2. Description of Related Art

A Serial ATA (Serial Advanced Technology Attachment) electrical connector has functions of simultaneously supplying currents with difference voltages and high speed transferring electrical signal information, so is suitable to be used for electrically connecting a data storing device, e.g. a hard disk or an optical disk, and a circuit board.

The Taiwan Utility Patent No. M330596, titled “Electrical connector” has disclosed an electrical connector, characterized in that a rear surface of an insulation housing of said electrical connector is respectively installed with a plurality of first terminal channels extending toward an insertion surface and a plurality of second terminal channels extending toward the insertion surface, the first terminal channels and the second terminal channels are arranged with a transversal means, and the rear surface is installed with a retraction surface communicating with each of the second terminal channels.

The Taiwan Utility Patent No. M330597, titled “Electrical connector” has disclosed an electrical connector, characterized in that depths of which positioning portions of first conduction terminals installed in terminal channels are different.

The Taiwan Utility Patent No. M271281, titled “Electrical connector” has disclosed an electrical connector, characterized in that a recess portion of said electrical connector is installed with a first ladder surface and a second ladder surface.

Though the mentioned patents are able to solves problems which they are invented for, the mentioned patents still have following disadvantages: 1. Retaining forces of the conduction terminals are small so the conduction terminals may shake and rotate; 2. the insulation housing is not installed with any scoop hole or I-shaped slot, so production cost is relatively higher; 3. the location between each positioning portion and a corresponding contact portion of the conduction terminals is bended so production cost is high and distance for signal transferring is increased.

### SUMMARY OF THE INVENTION

One object of the present invention is to provide an electrical connector, in which at least one scoop hole is installed on an insulation housing for reducing the shrinking and deformation of the insulation housing.

Another object of the present invention is to provide an electrical connector, in which at least one I-shaped slot is installed on a rear surface of an insulation housing for not only increasing pressures of interfere areas of first conduction terminals and second conduction terminals but also enhancing the installed distance and stability of the first conduction terminals and the second conduction terminals.

One another object of the present invention is to provide an electrical connector, in which each positioning portion of conduction terminals has at least one reversed-hook portion or at least one pierce portion for preventing the conduction terminals from shaking and rotating.

One another object of the present invention is to provide an electrical connector, in which each contact portion of conduction terminals is extended toward a direction of a positioning portion for shortening the distance for signal transferring and for saving material.

One another object of the present invention is to provide an electrical connector, in which two ends of an insulation housing are respectively installed with a fastening block having a ladder-shaped seat for respectively receiving and fastening a locking sheet, so the insulation housing is fastened on a circuit board.

For achieving the objects mentioned above, one solution provided by the present invention is to provide an electrical connector, comprises: an insulation housing being installed with an insertion surface and a rear surface opposite to the insertion surface, the rear surface is respectively installed with a plurality of first terminal channels extending toward the insertion surface and a plurality of second terminal channels extending toward the insertion surface, the first terminal channels and the second terminal channels are arranged with a transversal means; a plurality of first conduction terminals respectively received in the first terminal channels for transferring power signals, and each of the first conduction terminals has a contact portion, a positioning portion and a jointing portion, wherein at least one end of the positioning portion is installed with at least one reversed-hook portion or at least one pierce portion for preventing the first conduction terminals from shaking and rotating; and a plurality of second conduction terminals respectively received in the second terminal channels for transferring signals, and each of the second conduction terminals has a contact portion, a positioning portion and a jointing portion, wherein at least one end of the positioning portion is installed with at least one reversed-hook portion or at least one pierce portion for preventing the second conduction terminals from shaking and rotating.

For achieving the objects mentioned above, another solution provided by the present invention is to provide an electrical connector, comprises: an insulation housing being installed with an insertion surface and a rear surface opposite to the insertion surface, the rear surface is respectively installed with a plurality of first terminal channels extending toward the insertion surface and a plurality of second terminal channels extending toward the insertion surface, the insertion surface is installed with at least one scoop hole, and the rear surface is installed with at least one I-shaped slot; a plurality of first conduction terminals respectively received in the first terminal channels for transferring power signals, and each of the first conduction terminals has a contact portion, a positioning portion and a jointing portion; and a plurality of second conduction terminals respectively received in the second terminal channels for transferring signals, and each of the second conduction terminals has a contact portion, a positioning portion and a jointing portion.

For achieving the objects mentioned above, another solution provided by the present invention is to provide an electrical connector, comprises: an insulation housing being installed with an insertion surface and a rear surface opposite to the insertion surface, the rear surface is respectively installed with a plurality of first terminal channels extending toward the insertion surface and a plurality of second terminal channels extending toward the insertion surface, and two ends of the insulation housing are respectively installed with a fastening block having a ladder shaped seat; a plurality of first conduction terminals respectively received in the first terminal channels for transferring power signals, and each of the first conduction terminals has a contact portion, a positioning portion and a jointing portion; a plurality of second conduction terminals respectively received in the second terminal channels for transferring signals, and each of the second conduction terminals has a contact portion, a positioning portion and a jointing portion; and two locking sheets being installed and fastened in the ladder shaped seats of the fastening blocks so the insulation housing is fastened on a circuit board.

### BRIEF DESCRIPTION OF THE DRAWINGS

FIG. 1 is a schematic exploded view of the electrical connector of one preferred embodiment of the present invention;

FIG. 2 is a schematic enlarged view illustrating the first conduction terminal and the second conduction terminal of one preferred embodiment of the present invention;

FIG. 3 is a schematic view of the assembly of the electrical connector of one preferred embodiment of the present invention;

FIG. 4 is a cross sectional view of the electrical connector of one preferred embodiment of the present invention.

### DETAILED DESCRIPTION OF THE PREFERRED EMBODIMENT

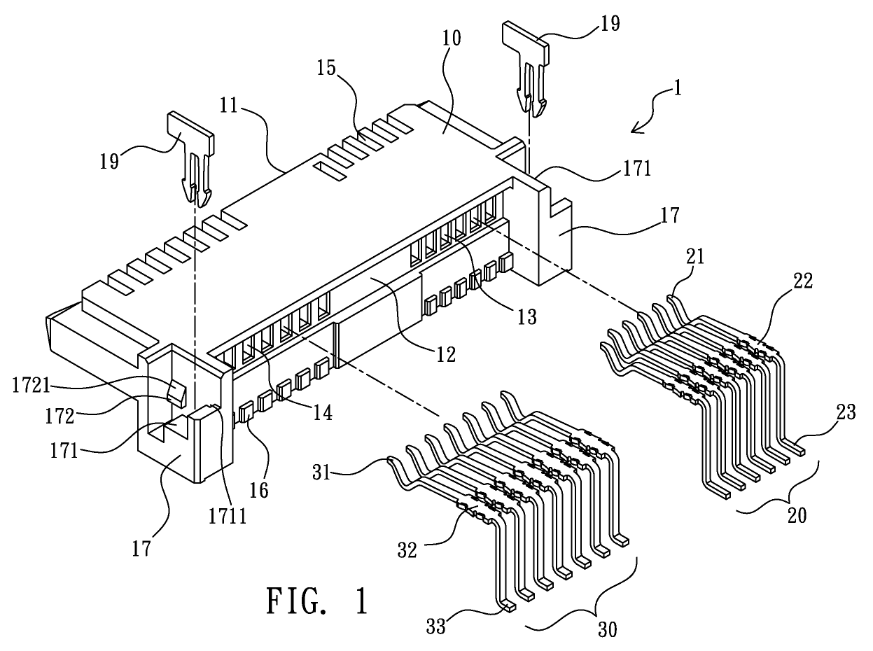

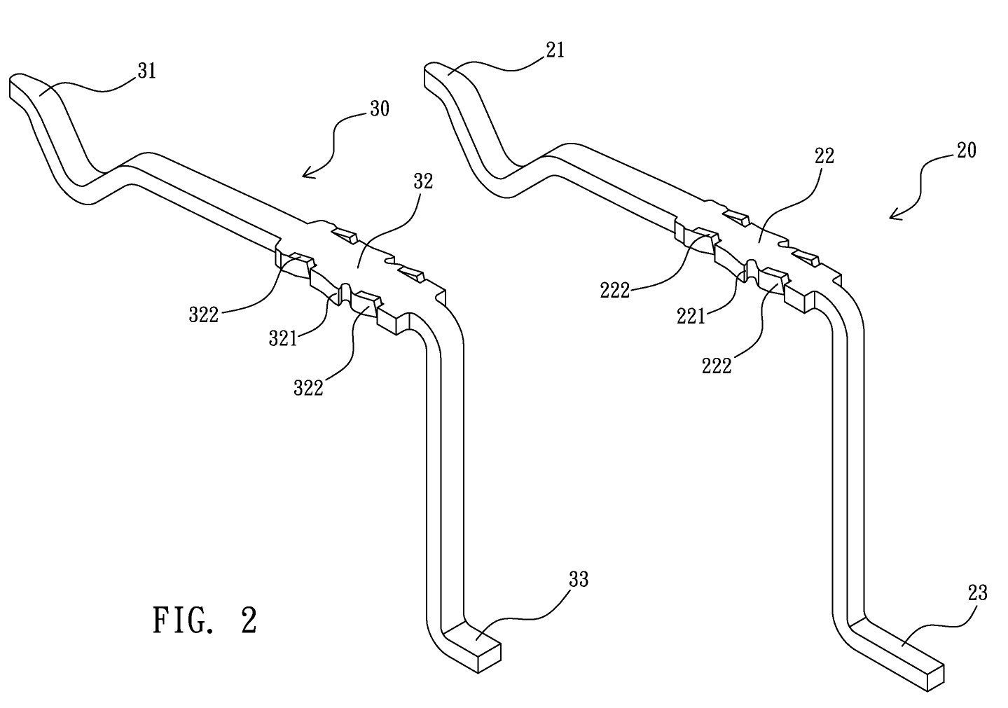

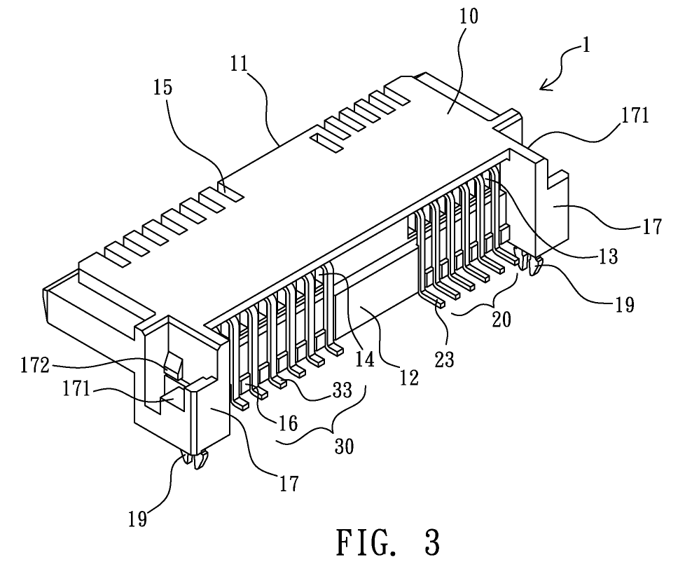

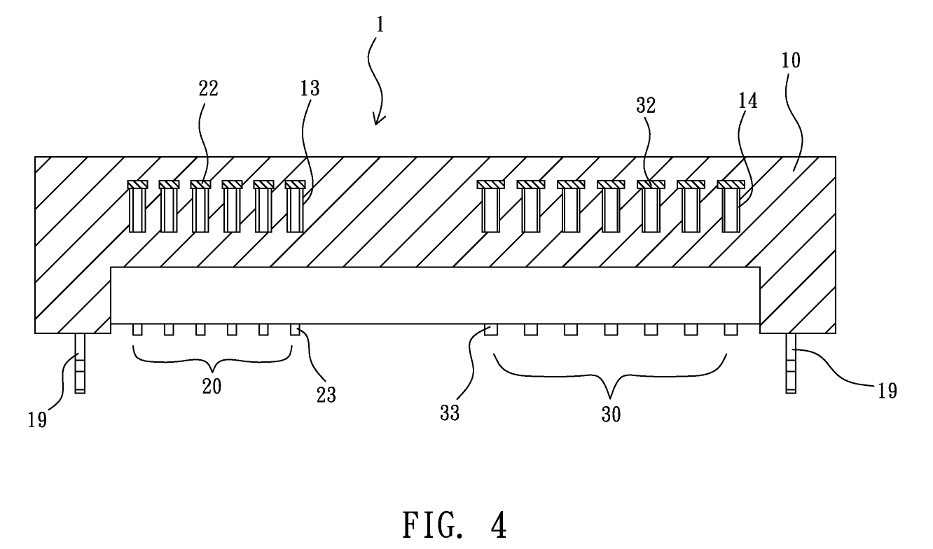

Referring to FIG. 1 to FIG. 4, wherein FIG. 1 is a schematic exploded view of the electrical connector of one preferred embodiment of the present invention; FIG. 2 is a schematic enlarged view illustrating the first conduction terminal and the second conduction terminal of one preferred embodiment of the present invention; FIG. 3 is a schematic view of the assembly of the electrical connector of one preferred embodiment of the present invention; FIG. 4 is a cross sectional view of the electrical connector of one preferred embodiment of the present invention.

As shown in figures, the electrical connector 1 provided by the present invention comprises: an insulation housing 10; a plurality of first conduction terminals 20; and a plurality of second conduction terminals 30.

The insulation housing 10 is installed with an insertion surface 11 and a rear surface 12 provided opposite to the insertion surface 11. The rear surface 12 is respectively installed with a plurality of first terminal channels 13 extending toward the insertion surface 11 and a plurality of second terminal channels 14 extending toward the insertion surface 11, and the first terminal channels 13 and the second terminal channels 14 are transversally installed; wherein the insulation housing 10 is made of, e.g. but not limited to, plastic material. The art are conventional and well known by skilled people in the art, therefore no further illustration is provided.

The insertion surface 11 of the insulation housing 10 is further installed with at least one scoop hole 15, so that the plastic material of which the insulation housing 10 is made can be saved and the insulation housing 10 is prevented from shrinking and deforming.

The rear surface 12 of the insulation housing 10 is further installed with at least one I-shaped slot 16, so not only pressures at interfere areas of the first conduction terminals 20 and the second conduction terminals 30 are increased, but also the installed distance and stability of the first conduction terminals 20 and the second conduction terminals 30 are enhanced.

Two ends of the insulation housing 10 are respectively installed with a fastening block 17 having a ladder-shaped seat 171 and a latching block 172; wherein one end of the ladder-shaped seat 171, e.g. but not limited to an inner side thereof, is installed with a guiding slot 1711, so a locking sheet 19 is able to sleeve in the guiding slot 1711, and the latching block 172 is installed on a lateral surface of the fastening block 17 and is disposed above the ladder-shaped seat 171, two ends of the latching block 172 are respectively installed with a guiding angle 1721 so that the locking sheet 19 is prevented from releasing from the fastening block 17, thus the insulation housing 10 is able to be fastened on a circuit board (not shown); wherein through the locking sheet 19 cooperating with the ladder-shaped seat 171, the length of the insulation housing 10 can be shortened, so objects of saving material and reducing space occupied by the electrical connector 1 are achieved.

The first conduction terminals 20 are respectively received in the first terminal channels 13 for transferring power signals, each of the first conduction terminals 20 has a contact portion 21, a positioning portion 22 and a jointing portion 23, as shown in FIG. 2, two ends of the positioning portion 22 are respectively installed with at least one reversed-hook portion 221 or at least one pierce portion 222 for preventing the first conduction terminals 20 from shaking or rotating; in this embodiment, for illustration, the two ends of the positioning portion 22 are respectively installed with two reversed-hook portions 221 and two pierce portions 222. The two reversed-hook portions 221 are, e.g. but not limited to, transversally installed and the two pierce portions 222 are, e.g. but not limited to, longitudinally installed. Each contact portion 21 of the first conduction terminals 20 is extended toward the direction of the positioning portion 22 (in other words in a non-bending status), so distance for signal transferring is shortened and the material used is saved.

The second conduction terminals 30 are respectively received in the second terminal channels 14 for transferring signals, and each of the second conduction terminals 30 has a contact portion 31, a positioning portion 32 and a jointing portion 33, as shown in FIG. 2, two ends of the positioning portion 32 are respectively installed with at least one reversed-hook portion 321 or at least one pierce portion 322 for preventing the second conduction terminals 30 from shaking or rotating; in this embodiment, for illustration, the two ends of the positioning portion 32 are respectively installed with two reversed-hook portions 321 and two pierce portions 322. The two reversed-hook portions 321 are, e.g. but not limited to, transversally installed and the two pierce portions 322 are, e.g. but not limited to, longitudinally installed. Each contact portion 31 of the second conduction terminals 30 is extended toward the direction of the positioning portion 32 (in other words in a non-bending status), so distance for signal transferring is shortened and the material used is saved.

As shown in FIG. 3 and FIG. 4, when being assembled, the first conduction terminals 20 are respectively received in the first terminal channels 13, the second conduction terminals 30 are respectively received in the second terminal channels 14; then two locking sheets 19 are respectively disposed and fastened in the fastening blocks 17, so the assembly of the electrical connector 1 of the present invention is finished.

As mentioned above, the electrical connector of the present invention has following advantages, compared to a conventional electrical connector: 1. at least one scoop hole is installed on the insulation housing for reducing the shrinking and deformation of the insulation housing; 2. at least one I-shaped slot is further installed on the rear surface of the insulation housing for not only increasing pressures of interfere areas of the first conduction terminals and the second conduction terminals, but also enhancing the installed distance and stability of the first conduction terminals and the second conduction terminals; 3. each positioning portion of the conduction terminals has at least one reversed-hook portion or at least a pierce portion for preventing the conduction terminals from shaking and rotating; 4. each contact portion of the conduction terminals is extended toward the direction of the positioning portion for shortening the distance for signal transferring and saving material used; 5. two ends of the insulation housing are respectively installed with a fastening block having a ladder shaped seat for respectively receiving and fastening a locking sheet so that the length of the insulation housing is shortened, objects of saving material and reducing the space occupied by the electrical connector 1 are achieved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector, comprising:
an insulation housing having an insertion surface and a rear surface located opposite to the insertion surface, the rear surface having a plurality of first terminal channels located on a first end thereof and extending toward the insertion surface and a plurality of second terminal channels located on a second end thereof and extending toward the insertion surface, the first terminal channels and the second terminal channels being parallel;
a plurality of first conduction terminals respectively received in the first terminal channels for transferring power signals, and each of the first conduction terminals having a contact portion, a positioning portion and a jointing portion, wherein at least one end of the positioning portion being installed with at least one reversed-hook portion or at least one pierce portion at least one reversed-hook portion or at least one pierce portion for preventing the first conduction terminals from shaking and rotating; and
a plurality of second conduction terminals respectively received in the second terminal channels for transferring signals, and each of the second conduction terminals having a contact portion, a positioning portion and a jointing portion, wherein at least one end of the positioning portion being installed with at least one reversed-hook portion or at least one pierce portion for preventing the second conduction terminals from shaking and rotating;
wherein the plurality of first conduction terminals are inserted into the first end of the rear surface of the insulation housing and the plurality of second conduction terminals are inserted into the second end of the rear surface of the insulation housing;
wherein each positioning portion of the first conduction terminals and each positioning portion the second conduction terminals have two sets of pierce portions and two reversed-hook portions, the two reversed-hook portions are located between the two sets of pierce portions and extend outwardly from opposing sides of the positioning portion, each set of pierce portions of the two sets of pierce portions has two pierce portions protruding upwardly from a top surface of the positioning portion.

2. (canceled)

3. The electrical connector as claimed in claim 1, wherein the insertion surface of the insulation housing is further installed with at least one scoop hole for reducing the shrinking and deformation of the insulation housing.

4. The electrical connector as claimed in claim 1, wherein the rear surface of the insulation housing is further installed with at least one I-shaped slot for not only increasing pressures of interfere areas of the first conduction terminals and the second conduction terminals but also enhancing the installed distance and stability of the first conduction terminals and the second conduction terminals.

5. The electrical connector as claimed in claim 1, wherein each of the contact portions of the first conduction terminals and each of the contact portions of the second conduction terminals are extended toward the direction of the positioning portion for not only shortening distance for signal transferring but also saving material.

6. The electrical connector as claimed in claim 1, wherein two ends of the insulation housing are respectively installed with a fastening block, the fastening block has a ladder shaped seat and a latching block, one end of the ladder shaped seat has a guiding slot, a locking sheet is inserted into the guiding slot, the latching block is located on a lateral surface of the fastening block and has a guiding angle located on a top thereof, the latching block locking the locking sheet in the guiding slot of the ladder shaped seat and locking the entire locking sheet below the latching block of the fastening block, so the insulation housing is fastened on a circuit board.

7. An electrical connector, comprising:
an insulation housing having an insertion surface and a rear surface located opposite to the insertion surface, the rear surface having a plurality of first terminal channels located on a first end thereof and extending toward the insertion surface and a plurality of second terminal channels located on a second end thereof and extending toward the insertion surface, the insertion surface is installed with at least one scoop hole, and the rear surface is installed with at least one I-shaped slot;
a plurality of first conduction terminals respectively received in the first terminal channels for transferring power signals, and each of the first conduction terminals has a contact portion, a positioning portion and a jointing portion; and
a plurality of second conduction terminals respectively received in the second terminal channels for transferring signals, and each of the second conduction terminals has a contact portion, a positioning portion and a jointing portion;
wherein the plurality of first conduction terminals are inserted into the first end of the rear surface of the insulation housing and the plurality of second conduction terminals are inserted into the second end of the rear surface of the insulation housing;
wherein each positioning portion of the first conduction terminals and each positioning portion the second conduction terminals have two sets of pierce portions and two reversed-hook portions, the two reversed-hook portions are located between the two sets of pierce portions and extend outwardly from opposing sides of the positioning portion, each set of pierce portions of the two sets of pierce portions has two pierce portions protruding upwardly from a top surface of the positioning portion.

8. (canceled)

9. The electrical connector as claimed in claim 7, wherein each of the contact portions of the first conduction terminals and each of the contact portions of the second conduction terminals are extended toward the direction of the positioning portion for not only shortening distance for signal transferring but also saving material.

10. The electrical connector as claimed in claim 7, wherein two ends of the insulation housing are respectively installed with a fastening block, the fastening block has a ladder shaped seat and a latching block, one end of the ladder shaped seat has a guiding slot, a locking sheet is inserted into the guiding slot, the latching block is located on a lateral surface of the fastening block and has a guiding angle located on a top thereof, the latching block locking the locking sheet in the guiding slot of the ladder shaped seat and locking the entire locking sheet below the latching block of the fastening block, so the insulation housing is fastened on a circuit board.

11. An electrical connector, comprising:
an insulation housing having an insertion surface and a rear surface located opposite to the insertion surface, the rear surface having a plurality of first terminal channels located on a first end thereof and extending toward the insertion surface and a plurality of second terminal channels located on a second end thereof and extending toward the insertion surface, and two ends of the insulation housing are respectively installed with a fastening block having a ladder shaped seat;
a plurality of first conduction terminals respectively received in the first terminal channels for transferring power signals, and each of the first conduction terminals has a contact portion, a positioning portion and a jointing portion;
a plurality of second conduction terminals respectively received in the second terminal channels for transferring signals, and each of the second conduction terminals has a contact portion, a positioning portion and a jointing portion; and
two locking sheets being installed and fastened in the ladder shaped seats of the fastening blocks so the insulation housing is fastened on a circuit board;
wherein the plurality of first conduction terminals are inserted into the first end of the rear surface of the insulation housing and the plurality of second conduction terminals are inserted into the second end of the rear surface of the insulation housing;
wherein each positioning portion of the first conduction terminals and each positioning portion the second conduction terminals have two sets of pierce portions and two reversed-hook portions, the two reversed-hook portions are located between the two sets of pierce portions and extend outwardly from opposing sides of the positioning portion, each set of pierce portions of the two sets of pierce portions has two pierce portions protruding upwardly from a top surface of the positioning portion.

12. (canceled)

13. The electrical connector as claimed in claim 11, wherein each of the contact portions of the first conduction terminals and each of the contact portions of the second conduction terminals are extended toward the direction of the positioning portion for not only shortening distance for signal transferring but also saving material.

14. The electrical connector as claimed in claim 11, wherein the insertion surface of the insulation housing is further installed with at least one scoop hole for reducing the shrinking and deformation of the insulation housing.

15. The electrical connector as claimed in claim 11, wherein the rear surface of the insulation housing is further installed with at least one I-shaped slot for not only increasing pressures of interfere areas of the first conduction terminals and the second conduction terminals but also enhancing the installed distance and stability of the first conduction terminals and the second conduction terminals.

16. The electrical connector as claimed in claim 11, wherein one end of the ladder shaped seat has a guiding slot, a locking sheet of the two locking sheets is inserted into the guiding slot, a latching block is located on a lateral surface of the fastening block, the latching block has a guiding angle located on a top thereof, the latching block locking the locking sheet in the guiding slot of the ladder shaped seat and locking the entire locking sheet below the latching block of the fastening block, so the insulation housing is fastened on a circuit board.
